(19) United States
(12) Patent Application Publication
(10) Pub. No.: US 2012/0287778 A1
(43) Pub. Date: Nov. 15, 2012

(54) TRANSMISSION APPARATUS AND PATH SWITCHING METHOD

(75) Inventor: Satoru Saitoh, Kawasaki (JP)

(73) Assignee: FUJITSU LIMITED, Kawasaki-shi (JP)

(21) Appl. No.: 13/428,715

(22) Filed: Mar. 23, 2012

(30) Foreign Application Priority Data
May 11, 2011 (JP) 2011-105771

(51) Int. Cl. H04L 12/26

(52) U.S. Cl. 370/228

(57) ABSTRACT

There is provided a transmission apparatus including a receiver unit configured to receive, from a network on a first layer, fault information regarding the network on the first layer, and a generator unit configured to generate, based on the fault information received by the receiver unit, switch information used to switch a transmission path of a network on a second layer higher than the first layer.

### CROSS-REFERENCE TO RELATED APPLICATION

This application is based upon and claims the benefit of priority of the prior Japanese Patent Application No. 2011-105771, filed on May 11, 2011, the entire contents of which are incorporated herein by reference.

### FIELD

The embodiments discussed herein are related to a transmission apparatus that transmits data and a path switching method for the same.

### BACKGROUND

Optical transport network (OTN) technology, which is standardized under G. 709 of ITU-T (International Telecommunication Union-Telecommunication Standardization Sector), enables various client signals to be transmitted over a common optical network. For example, in a packet network using Ethernet® signals to connect nodes, Ethernet® is mapped into OTN, thus providing wide-area transmission.

When a packet network is mapped into an OTN, as in the above example, the topology information (information on the manner in which terminals and transmission apparatuses included in a packet network are connected) of the packet network is separate information from the topology information (information on the manner in which terminals and transmission apparatuses included in the OTN are connected) of the OTN. For this reason, redundant switching in the OTN and redundant switching in the packet network are performed independently.

The communications network system disclosed in Japanese Laid-open Patent Publication No. 2009-239359 is a network system that operates independently of convergence time of a routing protocol and is capable of quickly causing a signal to detour through a plurality of paths without contention over resources for setting detour routes even in the case of multiple failures.

Japanese Laid-open Patent Publication No. 2004-193812 provides a method of building a network utilizing digital wrapper technology.

### SUMMARY

According to an aspect of the embodiment, there is provided a transmission apparatus including a receiver unit configured to receive, from a network on a first layer, fault information regarding the network on the first layer, and a generator unit configured to generate, based on the fault information received by the receiver unit, switch information used to switch a transmission path of a network on a second layer higher than the first layer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a transmission apparatus according to a first embodiment;

FIG. 2 illustrates an operation example of transmission apparatuses;

FIG. 3 is a flowchart illustrating an operation example of the transmission apparatus in FIG. 2;

FIG. 4 illustrates an example of an OTN to which a transmission apparatus according to a second embodiment is applied;

FIG. 5 is an explanatory illustration of an FTFL message;

FIG. 6 illustrates an example of blocks of a node;

FIG. 7 illustrates an exemplary data structure of a recovery table (TB);

FIG. 8 illustrates an exemplary data structure of a recovery TB according to a third embodiment;

FIG. 9 is a flowchart illustrating the operation of a node;

FIG. 10 illustrates an example of an OTN to which a transmission apparatus according to a fourth embodiment is applied;

FIG. 11 illustrates an exemplary data structure of a recovery TB; and

FIG. 12 illustrates an exemplary data structure of a recovery TB according to a fifth embodiment.

### DESCRIPTION OF EMBODIMENTS

For example, assume that a fault occurs in an OTN on a layer 1 (physical layer) and redundant switching of a transmission path is performed in the OTN. In this case, the redundant switching in the OTN on the layer 1 and the redundant switching in the packet network on a layer 2 (data link layer) are performed independently of each other. For this reason, in the packet network on the layer 2, connectivity is momentarily lost by the redundant switching in the OTN on the layer 1, and therefore redundant switching of the transmission path may be performed even when redundant switching of the transmission path of the packet network on the layer 2 is unnecessary.

Hereinbelow, embodiments of a transmission apparatus and a path switching method that reduce such unnecessary switching of a transmission path will be described in detail with reference to the drawings.

### First Embodiment

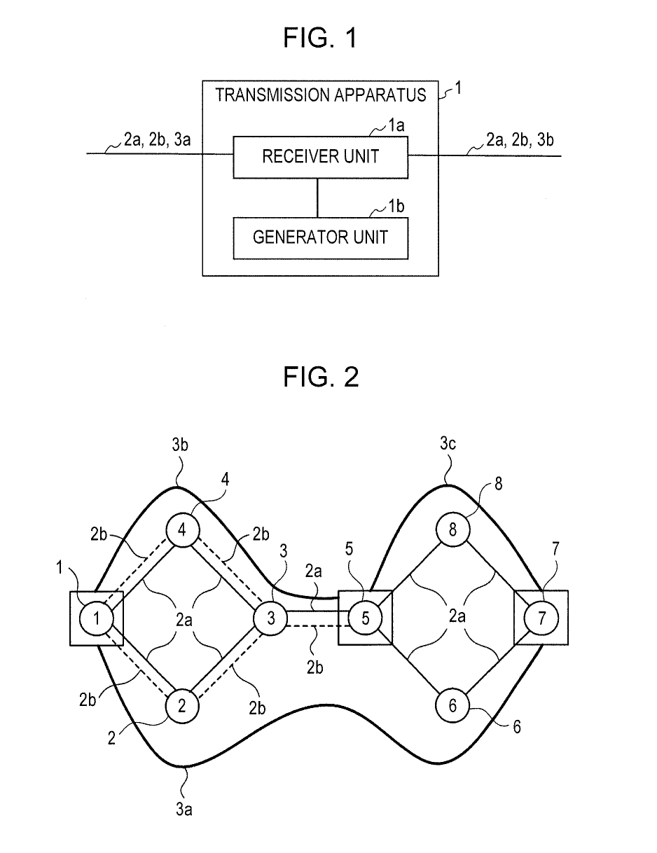

FIG. 1 illustrates a transmission apparatus according to a first embodiment. As illustrated in FIG. 1, a transmission apparatus 1 includes a receiver unit 1a and a generator unit 1b.

The receiver unit 1a receives, through a path 2a from a network on a first layer, fault information regarding the network on the first layer. For example, the receiver unit 1a receives information regarding faults in an OTN from the OTN. The fault information contains a position at which a fault has occurred (hereinbelow referred to as the “fault occurrence position”) in the OTN, for example.

The generator unit 1b generates, on the basis of the fault information received by the receiver unit 1a, switch information on a transmission path of a network on a second layer that is higher than the first layer. For example, the generator unit 1b generates, on the basis of the fault information received by the receiver unit 1a, switch information on a transmission path of a packet network on a layer higher than the OTN. Specifically, on the basis of the fault information received by the receiver unit 1a, the generator unit 1b generates switch information including information to the effect that the transmission path of the packet network is to be switched, if a fault has occurred at a location where there is no reserve line of the OTN. For example, the generator unit 1b includes a memory for storing program data, a processor for executing a program, a circuit, and a field programmable gate array (FPGA).

FIG. 2 illustrates an operation example of transmission apparatuses. The topologies of the OTN and the packet network are illustrated in FIG. 2. A path 2a illustrated in FIG. 2 represents the currently used line of the OTN. A path 2b represents a reserve line of the OTN. Paths 3a to 3c represent the packet network.

Circled numbers 1 to 8 illustrated in FIG. 2 indicate the transmission apparatuses of the OTN on the layer 1, which will be referred to as transmission apparatuses 1 to 8, respectively. The transmission apparatuses denoted by numbers 1, 5, and 7 enclosed in boxes are transmission apparatuses that further handle the layer 2.

Assume that a packet is transmitted rightward from the left in FIG. 2. For example, a packet is transmitted from the transmission apparatus 1 to the transmission apparatus 7, as illustrated in the path 3a. A packet is also transmitted from the transmission apparatus 1 to the transmission apparatus 5, as illustrated in the path 3b. A packet is also transmitted from the transmission apparatus 5 to the transmission apparatus 7, as illustrated in the path 3c.

Assume that it has become impossible for the transmission apparatus 6 to receive a signal from the transmission apparatus 5. The transmission apparatus 6 detects that a fault has occurred in the OTN between the transmission apparatus 5 and the transmission apparatus 6, and transmits fault information to that effect to the upstream transmission apparatus 1.

The receiver unit 1a of the transmission apparatus 1 receives the fault information regarding the OTN. On the basis of the fault information received by the receiver unit 1a, the generator unit 1b generates switch information on the transmission path of the packet network.

For example, in the case of the above example, the fault has occurred at the position without a reserve line of the OTN. In this case, the generator unit 1b generates switch information including information to the effect that the transmission path of the packet network is to be switched. Note that the generated switch information is output to a path controller, which is not illustrated in FIG. 1, for example. On the basis of the received switch information, the path controller switches the path along which a packet is to be transmitted, from the path 3a to the paths 3b and 3c.

The case where a fault has occurred at a location where there is a reserve line will be described. Assume that it has become impossible for the transmission apparatus 3 to receive a signal from the transmission apparatus 2. The transmission apparatus 3 detects that a fault has occurred in the OTN between the transmission apparatus 2 and the transmission apparatus 3, and transmits fault information to that effect to the upstream transmission apparatus 1.

The receiver unit 1a of the transmission apparatus 1 receives the fault information regarding the OTN. On the basis of the received fault information, the generator unit 1b generates switch information for the packet network.

For example, in the case of the above example, the fault has occurred at a position with a reserve line of the OTN. In this case, the generator unit 1b does not generate the switch information on the transmission path of the packet network.

Here, a description will be given of a case in which the transmission apparatus 1 is a transmission apparatus that does not include the receiver unit 1a and the generator unit 1b. In the case without the receiver unit 1a and the generator unit 1b, the transmission apparatus 1 performs redundant switching in the OTN on the layer 1 and redundant switching in the packet network on the layer 2 independently of each other.

For example, assume that a fault has occurred in the OTN between the transmission apparatus 2 and the transmission apparatus 3 and then redundant switching in the OTN has been performed from the currently used line to a reserve line. In this case, the redundant switching in the OTN causes the connectivity to be momentarily lost in the packet network. Therefore, the transmission apparatus 1 performs redundant switching of the transmission path in the packet network. For example, in the packet network of the path 3a, since the connectivity is momentarily lost by the redundant switching in the OTN between the transmission apparatus 2 and the transmission apparatus 3, the transmission apparatus 1 switches the transmission path of a packet from the path 3a to the paths 3b and 3c. That is, although a fault is removed in the OTN and therefore the transmission apparatus 1 does not have to switch the transmission path in the packet network, the transmission apparatus 1 switches the transmission path of the packet network.

However, in this embodiment, the generator unit 1b of the transmission apparatus 1 generates, on the basis of fault information received by the receiver unit 1a, switch information on the transmission path of the packet network higher than the OTN layer. That is, as described in the above example, even if a fault has occurred in the OTN between the transmission apparatus 2 and the transmission apparatus 3, the transmission apparatus 1 does not switch the transmission path of the packet network. This reduces unnecessary switching between transmission paths.

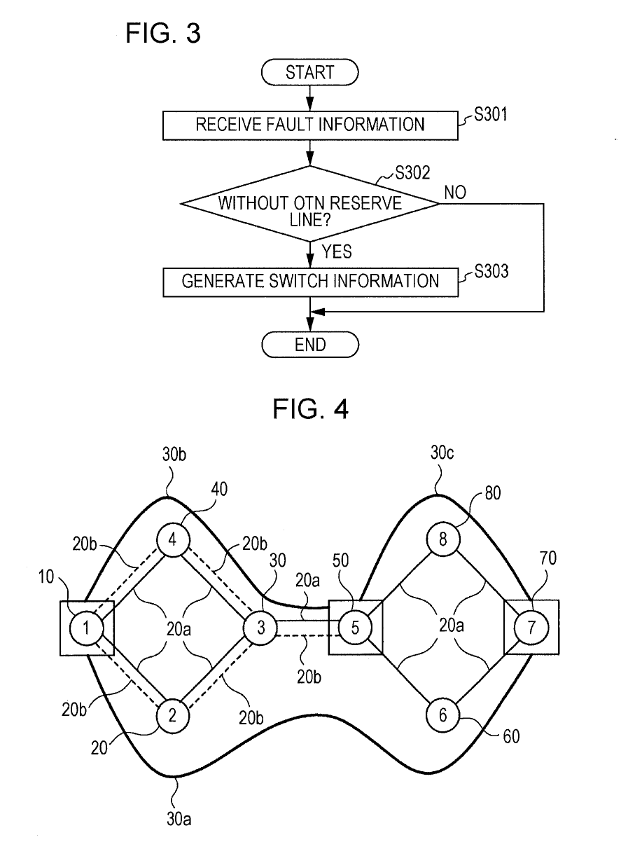

FIG. 3 is a flowchart illustrating an operation example of the transmission apparatus in FIG. 2.

[Operation S301] The receiver unit 1a receives fault information regarding a fault in the OTN from the OTN.

[Operation S302] On the basis of the fault information received by the receiver unit 1a, the generator unit 1b determines whether a fault has occurred at a location where there is no reserve line of the OTN. If the fault has occurred at a location where there is no reserve line of the OTN, the generator unit 1b goes to operation S303. If the fault has occurred at a location where there is a reserve line of the OTN, the generator unit 1b terminates the process.

[Operation S303] The generator unit 1b generates switch information including information to the effect that the transmission path of the packet network is to be switched.

As such, the receiver unit 1a of the transmission apparatus 1 receives, from the network on the first layer, fault information regarding a fault in the network on the first layer. Then, the generator unit 1b generates, on the basis of the fault information received by the receiver unit 1a, switch information on the transmission path of a network on the second layer higher than the first layer. In this way, the transmission apparatus 1 can reduce unnecessary switching of the transmission path.

### Second Embodiment

FIG. 4 illustrates an example of an OTN to which a transmission apparatus according to a second embodiment is applied. Circled numbers 1 to 8 illustrated in FIG. 4 indicate transmission apparatuses. Hereinbelow, the transmission apparatus may be referred to as a node.

The transmission apparatuses denoted by the circled numbers 1 to 8 are OTN nodes, for example, which will be referred to as nodes 10 to 80, respectively. The nodes 10 to 80 together form an OTN on the layer 1. A path 20a illustrated in FIG. 4 represents the currently used line of the OTN, and a path 20b represents a reserve line of the OTN. Thus, the nodes 10 to 50 can switch the line of the OTN from the currently used line to the reserve line at the time of occurrence of a fault. The nodes 60 to 80 may not switch the line of the OTN from the currently used line to the reserve line at the time of occurrence of a fault.

The nodes denoted by numbers 1, 5, and 7 enclosed in boxes are, for example, OTN nodes, and are also packet network nodes. The nodes 10, 50, and 70 together form a packet network on the layer 2.

The logic path of the packet network is formed by providing optical data unit (ODU) paths across the OTN to connect packet network nodes. For example, the node 10 and the node 70 are logically connected via the ODU path to form a path 30a of the packet network. The node 10 and the node 50 are logically connected via the ODU path to form a path 30b of the packet network. The node 50 and the node 70 are logically connected via the ODU path to form a path 30c of the packet network. Note that the nodes 20 to 40, 60, and 80 do not exist in the topology of the packet network, and therefore the path information regarding the packet network is information regarding connection between each of the nodes 10, 50, and 70. Hereinbelow, assume that a packet is transmitted rightward from the left in FIG. 4.

The node 10 receives a fault type and fault location reporting channel (FTFL) message of the OTN from the downstream nodes 20 to 80. On the basis of the received FTFL message, the node 10 generates switch information on the transmission path of the packet network.

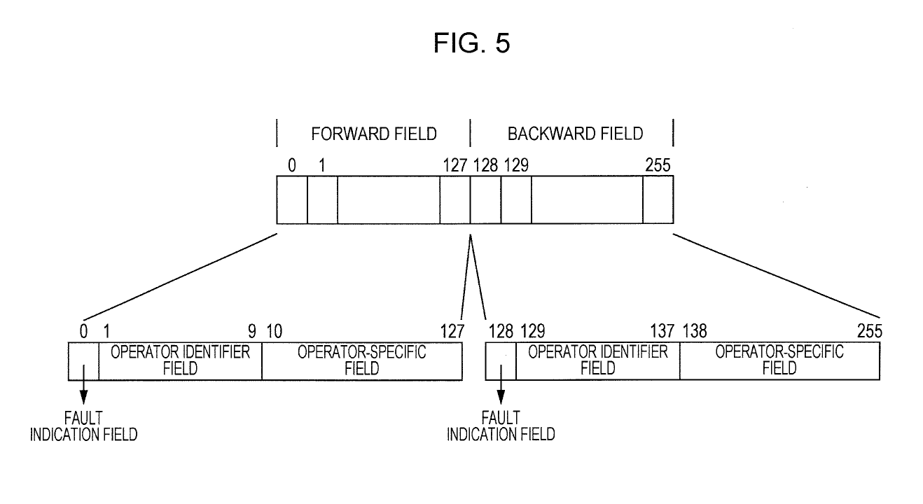

FIG. 5 is an explanatory illustration of an FTFL message. The FTFL message is formed of 256 bytes of data, as illustrated on the upper side of FIG. 5. The FTFL message can be divided into a forward field that is allocated to bytes 0 through 127 and a backward field that is allocated to bytes 128 through 255.

A node that has detected a fault, when transmitting an FTFL message to a downstream end node (e.g., the node 70), stores predetermined information in the forward field and transmits the FTFL message. The node that has detected a fault, when transmitting an FTFL message to an upstream starting node (e.g., the node 10), stores predetermined information in the backward field and transmits the FTFL message.

For example, assume that, with reference to FIG. 4, the node 60 has detected a fault between the node 50 and the node 60. In this case, when transmitting an FTFL message to the end node 70, the node 60 stores fault information in the forward field and transmits the FTFL message. When transmitting an FTFL message to the starting node 1, the node 60 stores fault information in the backward field and transmits the FTFL message.

Note that, the node that has detected a fault, when notifying the upstream starting node of fault information, may transmit an FTFL message to the end node, and then the end node may store the received fault information in the backward field of an FTFL message and transmit the FTFL message to the starting node. For example, assume that the node 60 has detected a fault between the node 50 and the node 60. In this case, the node 60 stores fault information in the forward field of an FTFL message and transmits the FTFL message to the node 70. The node 70 stores the received fault information in the backward field of an FTFL message and transmits the FTFL message to the node 10.

As illustrated in the lower left side of FIG. 5, the forward field includes a fault indication field, an operator identifier field, and an operator-specific field. As illustrated in the lower right side of FIG. 5, the backward field also includes the fault indication field, the operator identifier field, and the operator-specific field, like the forward field.

Information ‘NO FAULT’, ‘SIGNAL FAIL’, and ‘SIGNAL DEGRADE’ is stored in the fault indication field. Information on the fault occurrence position in the OTN is stored in the operator identifier field. The fault occurrence position is indicated, for example, by the identifier of a node that has detected a signal failure.

For example, with reference to FIG. 4, when a fault has occurred between the node 50 and the node 60, the node 60 detects the fault. In this case, the node 60 stores ‘SIGNAL FAIL’ in the fault indication field of an FTFL message, and stores the identifier (e.g., number 6) of the node 60 in the operator identifier field.

In the case of receiving signals from two or more paths, the node that has detected the fault further stores, in the operator identifier field, information on what is the direction of the path in which the fault has been detected. For example, with reference to FIG. 4, the node 30 receives signals from the node 20 and the node 40. In this case, the node 30 stores, in the operator identifier field, the identifier (e.g., number 3) of the node 30 and information on which of the path of the node 20 and the path of the node 40 is the path in which the fault has been detected.

Specifically, when a fault has occurred between the node 20 and the node 30, the node 30 stores, in the operator identifier field, the identifier of the node 30, and the identifier (e.g., number 2) of the node 20 indicating the fault path direction. When a fault has occurred between the node 40 and the node 30, the node 30 stores, in the operator identifier field, the identifier of the node 30 and the identifier (e.g., number 4) of the node 40 indicating the fault path direction.

Note that the node 10 can recognize the generation of a fault and the fault position by the received FTFL message. For example, the node 10 can recognize the generation of a fault from the fault indication field of the FTFL message. The node 10 can also recognize that there has been a signal failure between the node 5 and the node 6, for example, if number 6 is stored in the operator identifier field. The node 10 can also recognize that there has been a signal failure between the node 20 and the node 30, for example, if, in the operator identifier field, number 3 is stored and number 2 indicating the fault path direction is also stored. On the basis of the position at which the fault has occurred, the node 10 generates switch information including switch instruction information regarding the transmission path in the packet network on the layer 2.

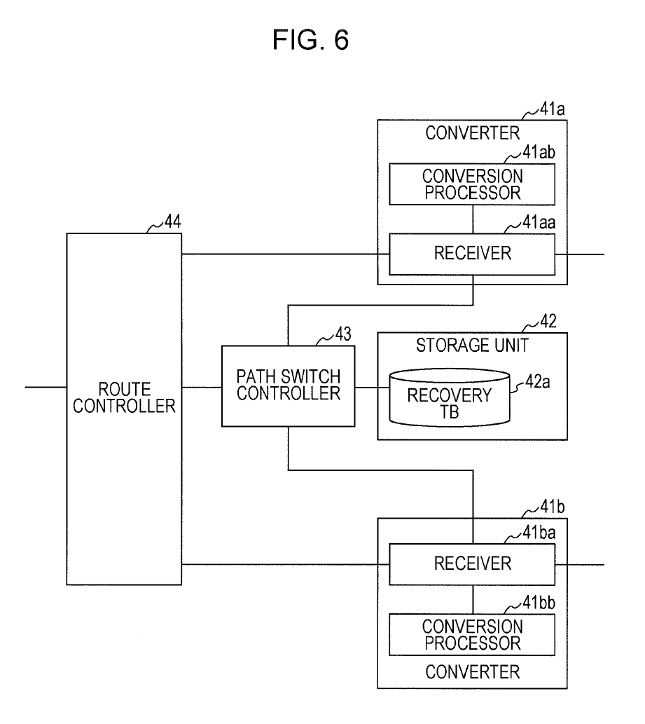

FIG. 6 illustrates an example of blocks of a node. As illustrated in FIG. 6, the node 10 includes converters 41a and 41b, a storage unit 42, a path switch controller 43, and a route controller 44.

The converters 41a and 41b are provided corresponding to lines of the OTN. For example, in FIG. 4, lines extend from the node 10 in two directions, toward the node 20 and toward the node 40. The converter 41a is connected to the line connected with the node 40, and the converter 41b is connected to the line connected with the node 20.

The converters 41a and 41b include receivers 41aa and 41ba and conversion processors 41ab and 41bb, respectively. The receiver 41aa and 41ba receive data transmitted over the packet network from the route controller 44. The conversion processors 41ab and 41bb convert the data transmitted over the packet network into the format of the OTN, and output the data to the OTN.

The receivers 41aa and 41ba receive data from the OTN. The conversion processors 41ab and 41bb convert the received data into the format of the packet network, and output the data to the route controller 44.

The converters 41a and 41b perform control of management information regarding the OTN, alarm detection, and so on. For example, if the receiver 41aa or 41ba detects a fault in the OTN, the conversion processor 41ab or 41bb generates an FTFL message, and outputs the FTFL message to the OTN. The receiver 41aa or 41ba receives the FTFL message from the OTN, and the conversion processor 41ab or 41bb outputs the received FTFL message to the path switch controller 43.

A recovery TB 42a is stored in the storage unit 42. In the recovery TB 42a, the fault occurrence position in the OTN is beforehand associated with the switch instruction information representing information on whether the transmission path of the packet network is to be switched or not.

For example, the converters 41a and 41b, the path switch controller 43, and the route controller 44 include memories for storing program data, processors for executing programs, circuits, and FPGAs. Note that an unit formed by the converters 41a and 41b of FIG. 6 corresponds to the receiver unit 1a of FIG. 1 and an unit formed by the path switch controller 43 and the route controller 44 of FIG. 6 corresponds to the generator unit 1b of FIG. 1.

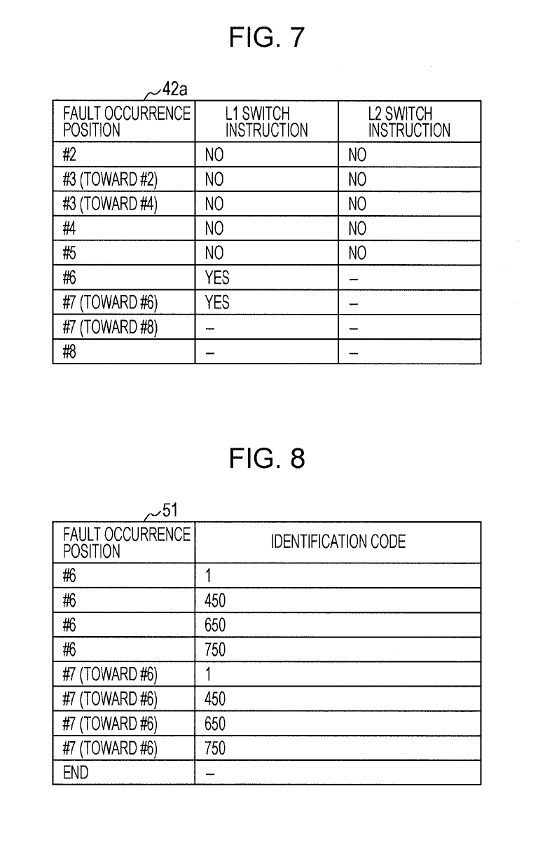

FIG. 7 illustrates an exemplary data structure of a recovery TB. As illustrated in FIG. 7, the recovery TB 42a has columns ‘FAULT OCCURRENCE POSITION’, ‘L1 SWITCH INSTRUCTION’, and ‘L2 SWITCH INSTRUCTION’.

The position at which a fault has occurred in the OTN is stored in the fault occurrence position column. For example, ‘#2’ of FIG. 7 indicates that a signal failure has occurred between the node 10 and the node 20 illustrated in FIG. 4 (downward signal failure). Also, ‘#3 (TOWARD #2)’ indicates that a signal failure has occurred between the node 20 and the node 30 illustrated in FIG. 4. Also, ‘#3 (TOWARD #4)’ indicates that a signal failure has occurred between the node 20 and the node 30 illustrated in FIG. 4.

Information on whether a path L1 of the packet network is to be switched is stored in the L1 switch instruction column. In the L1 switch instruction column, ‘NO’ indicates that the path L1 is not to be switched even if a fault has occurred in the OTN, and ‘YES’ indicates that the path L1 is to be switched to another path if a fault has occurred in the OTN.

For example, assume that the path 30a of FIG. 4 is the path L1. Further assume that the node 10 receives an FTFL message to the effect that a fault has occurred at ‘#2’. In this case, it can be seen from the recovery TB 42a that, as for the path L1, the path does not have to be switched. In addition, assume that the node 10 has received an FTFL message to the effect that a fault has occurred at ‘#6’. In this case, it can be seen from the recovery TB 42a that, as for the path L1, the path is to be switched. Hereinbelow, the path 30a of FIG. 4 may be referred to as the path L1.

Information on whether a path L2 of the packet network is to be switched is stored in the L2 switch instruction column. In the L2 switch instruction column, ‘NO’ indicates that the path L2 is not to be switched even if a fault has occurred in the OTN, and ‘YES’ indicates that the path L2 is to be switched to another path if a fault has occurred in the OTN.

For example, assume that the path 30b of FIG. 4 is the path L2. Further assume that the node 10 receives an FTFL message to the effect that a fault has occurred at ‘#2’. In this case, it can be seen from the recovery TB 42a that, as for the path L2, the path does not have to be switched. Hereinbelow, the path 30b of FIG. 4 may be referred to as the path L2.

In the L1 switch instruction column and the L2 switch instruction column, ‘-’ indicates invalidity. For example, the path L1 (the path 30a) does not spread between the node 80 and the node 70 of FIG. 4. Accordingly, the L1 switch instruction column associated with the fault occurrence position ‘#7 (TOWARD #8)’ of FIG. 7 is marked with ‘-’. Note that invalid information may be indicated by ‘NO’.

In the case where a reserve line of the OTN is present at a fault occurrence position of the path L1, ‘NO’ is stored in the L1 switch instruction column. For example, in FIG. 4, a reserve line spreads from the node 10 to the node 50. Accordingly, ‘NO’ is stored in the L1 switch instruction column associated with the fault occurrence positions ‘#2’ to ‘#5’, as illustrated in FIG. 7. That is, the node 10 does not switch the transmission path of the packet network on the layer 2, in the case where a fault is recovered in the OTN on the layer 1. The same applies to the L2 switch instruction column.

Path switch instruction columns are provided such that the number of them is equal to the number of paths of the packet network spreading from the node 10. For example, in FIG. 4, the paths L1 and L2 spread from the node 10. Accordingly, as illustrated in FIG. 7, the path switch instruction columns are the L1 switch instruction column and the L2 switch instruction column.

With reference back to FIG. 6, a description will be given. Upon receiving an FTFL message from the converter 41a or 41b, the path switch controller 43 refers to the recovery TB 42a on the basis of fault information included in the received FTFL message, and generates switch information on the transmission path in the packet network on a layer higher than OTN. The path switch controller 43 outputs the generated switch information to the route controller 44.

For example, referring to the recovery TB 42a on the basis of the fault occurrence position included in the FTFL message, the path switch controller 43 acquires information on the L1 switch instruction and the L2 switch instruction. The path switch controller 43 generates switch information including the acquired switch instruction information, and outputs the switch information to the route controller 44.

Specifically, in the case where the fault occurrence position included in an FTFL message is ‘#6’, the path switch controller 43 acquires, from the table illustrated in FIG. 7, information to the effect that the path L1 is to be switched. Then, the path switch controller 43 generates switch information including the information to the effect that the path L1 is to be switched. In the case where the fault occurrence position included in an FTFL message is ‘#2’, the path switch controller 43 acquires, from the table illustrated in FIG. 7, information to the effect that the paths L1 and L2 are not to be switched. The path switch controller 43 does not generate switch information when having acquired the information to the effect that the paths L1 and L2 are not to be switched.

The route controller 44 transmits and receives, for example, Ethernet® (IEEE 802. 3 equivalent) signals. For example, the route controller 44 analyzes a packet input from a packet interface (a packet input from the left of the route controller 44 illustrated in FIG. 6), determines a path along which the packet is to be output, and outputs the packet to the converter 41a or 41b. The route controller 44 also analyzes a packet output from the converter 41a or 41b, determines a path along which the packet is to be output, and outputs the packet to a predetermined packet interface.

The route controller 44 switches the transmission path of the packet network on the basis of switch information output from the path switch controller 43. For example, the route controller 44 stores the switch conditions of the paths L1 and L2 beforehand in a table that is not illustrated. For example, the conditions of changing the path L1 to the path L2 and changing the path L2 to the path L1 are stored in the table. Then, if switch information including a path L1 switch instruction is output from the path switch controller 43, the route controller 44 refers to the table that is not illustrated, and switches the path along which a packet is to be transmitted, from the path L1 to the path L2. If switch information including a path L2 switch instruction is output from the path switch controller 43, the route controller 44 refers to the table that is not illustrated, and switches the path along which a packet is to be transmitted, from the path L2 to the path L1.

Operation of the node 10 will be described. First, with reference to FIG. 4, the case where a signal failure in the OTN has occurred between the node 50 and the node 60 will be described.

Because of a signal failure between the node 50 and the node 60, it becomes impossible for the node 60 to receive a signal from the node 50. The node 60 stores information regarding a signal failure in the fault indication field of the backward field of an FTFL message, and stores a fault occurrence position ‘#6’ in the operator identifier field of the backward field. The node 60 transmits the generated FTFL message through the nodes 50, 30, and 20 to the starting node 10.

Note that the node 60 may store fault information in the forward field of an FTFL message, and transmit the FTFL message to the end node 70. The end node 70 stores the received fault information in the backward field, and transmits the FTFL message through the nodes 60, 50, 30, and 20 to the starting node 10.

The converter 41b of the node 10 receives the FTFL message. The converter 41b outputs the received FTFL message to the path switch controller 43.

The path switch controller 43 recognizes a signal failure in the OTN by the fault indication field of the FTFL message output from the converter 41b, refers to the recovery TB 42a on the basis of the FTFL message, and generates switch information. For example, in the above example, the path switch controller 43 acquires switch instruction information regarding the path L1 from the recovery TB 42a illustrated in FIG. 7. Following the acquired switch instruction, the path switch controller 43 generates switch information including information to the effect that the path L1 is to be switched. The path switch controller 43 outputs the generated switch information to the route controller 44.

The route controller 44 switches the path along which a packet is to be transmitted, from the path L1 to the path L2, using the switch information output from the path switch controller 43.

Next, with reference to FIG. 4, the case where a signal failure in the OTN has occurred between the node 20 and the node 30 will be described.

Because of a signal failure between the node 20 and the node 30, it becomes impossible for the node 30 to receive a signal from the node 20. The node 30 stores information regarding the signal failure in the fault indication field of the backward field of an FTFL message, and stores a fault occurrence position ‘#3 (TOWARD #2)’ in the operator identifier field of the backward field. The node 30 transmits the generated FTFL message through the node 20 to the starting node 10. Note that the node 30 may transmit the generated FTFL message to the end node 70, as described above.

The converter 41b of the node 10 receives the FTFL message. The converter 41b outputs the received FTFL message to the path switch controller 43.

The path switch controller 43 recognizes a signal failure in the OTN by the fault indication field of the FTFL message output from the converter 41b, refers to the recovery TB 42a on the basis of the FTFL message, and generates switch information. For example, in the above example, the path switch controller 43 acquires, from the recovery TB 42a illustrated in FIG. 7, switch instruction information to the effect that the paths L1 and L2 are not to be switched. Following the acquired switch instruction information, the path switch controller 43 does not generate switch information for switching the paths L1 and L2. Thus, the route controller 44 does not switch the transmission path of the packet network in the case where a signal failure in the OTN has occurred at a position with the reserve line of the OTN. That is, the route controller 44 does not switch the transmission path of the packet network, even if connectivity is lost momentarily (e.g., 50 ms) in the packet network because of redundant switching in the OTN.

Thus, the converter 41a or 41b of the node 10 receives, from the OTN on the layer 1, an FTFL message regarding the OTN. Then, the path switch controller 43 generates, on the basis of the FTFL message received by the converter 41a or 41b, switch information on the transmission path of the packet network on the layer 2 higher than the OTN. In this way, the node 10 can reduce unnecessary switching of a transmission path of the packet network.

Moreover, since the node 10 reduces unnecessary switching of a transmission path of the packet network, transmission delay of a packet can be suppressed. Moreover, in addition to reducing unnecessary switching of a transmission path, the node 10 switches the transmission path of the packet network for a line in which redundant switching is not performed in the OTN. Appropriate transmission path switching for the packet network can therefore be performed.

In order to reduce unnecessary switching of a transmission path of the packet network, it is thinkable that the reserve line is provided over all the nodes of the OTN, for example. However, if the reserve line in the same band (e.g., 10 GHz) as the line currently in use is secured in the OTN, it leads to an expensive network. In contrast, the node 10 can perform the appropriate switching of a transmission path without providing a reserve line over all the nodes of the OTN. That is, the node 10 allows the OTN to be formed at a low cost, and can perform appropriate switching of a transmission path of the packet network.

Note that, switching of a transmission path of the packet network has been described above regarding the node 10; however, the nodes 50 and 70 of the packet network nodes may also the same function as the node 10. That is, the nodes 50 and 70 each may also have the blocks illustrated in FIG. 6.

Moreover, the transmission path of the packet network on the layer 2 is switched in the above description; however, the transmission path of the packet network on a layer 3 (network layer) may be switched. For example, the path switch instruction information regarding the layer 3 is stored in the recovery TB 42a, and the path switch controller 43 outputs switch instruction information to the route controller of layer 3.

Moreover, the node 10 is both an OTN node and is a packet network node in the above description; however, the OTN node and the packet network node may be separate nodes. For example, the node 10 may be an OTN node, and another packet network node may have the route controller 44. That is, the route controller 44 may be external to the node 10.

Moreover, with reference to FIG. 6, the path switch controller 43 outputs the generated switch information to the route controller 44; however, the path switch controller 43 may generate switch information in the data format of the packet network (layer 2) and outputs the switch information to the converter 41a or the converter 41b. For example, the path switch controller 43 may generate a control packet in compliance to ITU-T Y. 1731 and the like, and output the control packet, including switch information, to the converter 41a or the converter 41b. The route controller 44 receives the control packet from the converter 41a or the converter 41b, and switches the transmission path of the packet network on the basis of the switch information included in the received control packet. In this case, a signal line between the path switch controller 43 and the route controller 44 becomes unnecessary. The same applies to the case where the route controller 44 is provided in a node different from the node 10.

Moreover, signal lines equivalent to the paths of the packet network spreading from the node 10, for example, may be connected between the path switch controller 43 and the route controller 44. For example, the signal lines corresponding to the paths L1 and L2 are connected between the path switch controller 43 and the route controller 44. Then, the path switch controller 43 may output switch information, as 1-bit information, to the route controller 44.

### Third Embodiment

A third embodiment will next be described in detail with reference to the drawings. In the second embodiment, information regarding a switching instruction is stored in the recovery TB for every path of the packet network. In the third embodiment, virtual local area network (VLAN)-IDs of VLANs are stored in the recovery TB. Hereinbelow, assume that an example of an OTN to which a node according to the third embodiment is applied is the same as that of FIG. 4.

FIG. 8 illustrates an exemplary data structure of a recovery TB according to the third embodiment. As illustrated in FIG. 8, a recovery TB 51 has columns ‘FAULT OCCURRENCE POSITION’ and ‘IDENTIFICATION CODE’.

The position at which a fault in the OTN has occurred is stored in the fault occurrence position column. In the fault occurrence position column of the recovery TB 51, only the fault occurrence position for which the transmission path of the packet network is to be switched when a signal failure has occurred is stored. For example, in the case where the transmission path of the packet network is not to be switched even if a signal failure has occurred at a fault occurrence position ‘#6’, ‘#6’ is not stored in the fault occurrence position column of FIG. 8.

In the identification code column, the VLAN-ID of a packet for which the transmission path of the packet network is to be switched when a fault has occurred in the OTN is stored. For example, in the case where a signal failure has occurred at ‘#6’, the paths of packets of VLAN-IDs ‘1’, ‘450’, ‘650’, and ‘750’ are to be switched. For packets of other VLAN-IDs, the transmission paths are not to be switched even if a signal failure has occurred at ‘#6’, and the packets will not be relieved. That is, VLAN-IDs of packets that are to be recovered when a signal failure has occurred are stored in the identification code column.

Note that ‘END’ of the recovery TB 51 indicates the end of the recovery TB 51.

The blocks of the node 10 according to the third embodiment are similar to those illustrated in FIG. 6. However, the blocks in both embodiments differ from each other in part of functions of the path switch controller 43 and the route controller 44. The path switch controller 43 and the route controller 44 according to the third embodiment will be described below.

Upon receiving an FTFL message from the converter 41a or 41b, the path switch controller 43 refers to the recovery TB 51 on the basis of fault information included in the received FTFL message, and generates switch information on the transmission path in the packet network. The path switch controller 43 outputs the generated switch information to the route controller 44.

For example, referring to the recovery TB 51 on the basis of the fault occurrence position included in the FTFL message, the path switch controller 43 acquires the VLAN-ID of a packet for which the transmission path is to be switched. The path switch controller 43 generates switch information including the acquired VLAN-ID, and outputs the switch information to the route controller 44.

Specifically, in the case where the fault occurrence position included in an FTFL message is ‘#6’, the path switch controller 43 search the recovery TB 51 illustrated in FIG. 8 sequentially from the top, and acquires VLAN-IDs ‘1’, ‘450’, ‘650’, and ‘750’. Every time the path switch controller 43 acquires a VLAN-ID, the path switch controller 43 generates switch information including the VLAN-ID, and outputs the switch information to the route controller 44.

The route controller 44 switches the transmission path of the packet network on the basis of the switch information output from the path switch controller 43. For example, the route controller 44 stores beforehand, in a table that is not illustrated, the condition “The paths of VLAN-IDs ‘1’, ‘450’, ‘650’, and ‘750’ are each switched from the path L1 to the path L2.” Then, when the switch information including VLAN-IDs ‘1’, ‘450’, ‘650’, and ‘750’ is output from the path switch controller 43, the route controller 44 refers to the table that is not illustrated, and switches the paths for transmission of the packets of VLAN-IDs ‘1’, ‘450’, ‘650’, and ‘750’ each from the path L1 to the path L2.

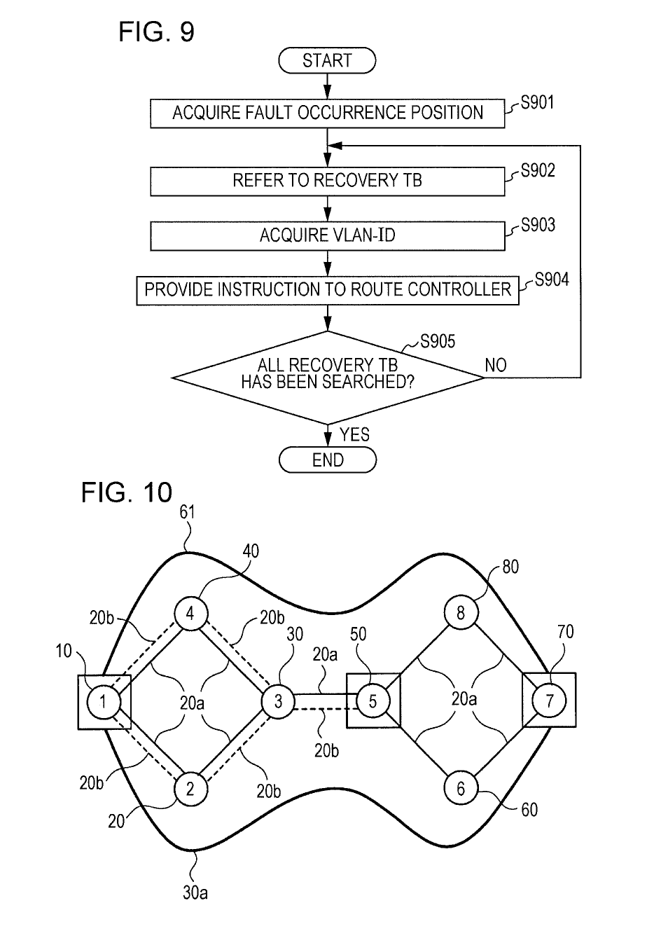

FIG. 9 is a flowchart illustrating the operation of a node.

[Operation S901] The path switch controller 43 acquires a fault occurrence position included in the FTFL message received from the converter 41a or 41b.

[Operation S902] The path switch controller 43 refers to the recovery TB 51 on the basis of the acquired fault occurrence position. The path switch controller 43 refers to the recovery TB 51 sequentially from the top, for example.

[Operation S903] The path switch controller 43 acquires, from the recovery TB 51, the VLAN-ID associated with the acquired fault occurrence position.

[Operation S904] The path switch controller 43 generates switch information including the acquired VLAN-ID. The path switch controller 43 outputs the generated switch information to the route controller 44.

[Operation S905] The path switch controller 43 determines whether all the information of the recovery TB 51 has been searched or not. For example, the path switch controller 43 determines whether all the information of the recovery TB 51 has been searched or not, depending on whether ‘END’ stored in the fault occurrence position of the recovery TB 51 has been detected or not. If all the information of the recovery TB 51 has not been searched, the path switch controller 43 goes to operation S902. If all the information of the recovery TB 51 has been searched, the path switch controller 43 finishes the process.

In this way, the converter 41a or 41b of the node 10 receives an FTFL message of the OTN from the OTN on the layer 1. Then, the path switch controller 43 acquires, on the basis of the FTFL message received by the converter 41a or 41b, the VLAN-ID of a packet on the layer 2 for which the transmission path is to be switched, and generates switch information including the acquired VLAN-ID. Thus, the node 10 can reduce unnecessary switching of the transmission path of the packet network.

Moreover, since the node 10 switches the transmission paths of packets depending on their VLAN-IDs, the node 10 can easily control a packet that is to be relieved and a packet that is not to be relieved by registering these packets to the recovery TB 51.

Moreover, since the node 10 can easily control a packet that is to be relieved and a packet that is not to be relieved by registering these packets to the recovery TB 51, an inexpensive VLAN can be formed.

Note that, in the case where a small number of kinds of VLAN-IDs are registered in the recovery TB 51, signal lines the number of which corresponds to the number of kinds of VLAN-IDs may be connected between the path switch controller 43 and route controller 44. Then, the path switch controller 43 may notify the VLAN-ID of a packet for which the path is to be switched, by a 1-bit signal.

### Fourth Embodiment

A fourth embodiment will next be described in detail with reference to the drawings. In the fourth embodiment, the packet transmission band after switching of the transmission path of the packet network is controlled.

FIG. 10 illustrates an example of an OTN to which a transmission apparatus according to a fourth embodiment is applied. In FIG. 10, the same elements as those illustrated in FIG. 4 are denoted by the same reference characters, and the description thereof will be omitted. In FIG. 10, the node 10 and the node 70 form the packet network of the path 30a and a path 61. Hereinbelow, the path 61 may be referred to as the path L2.

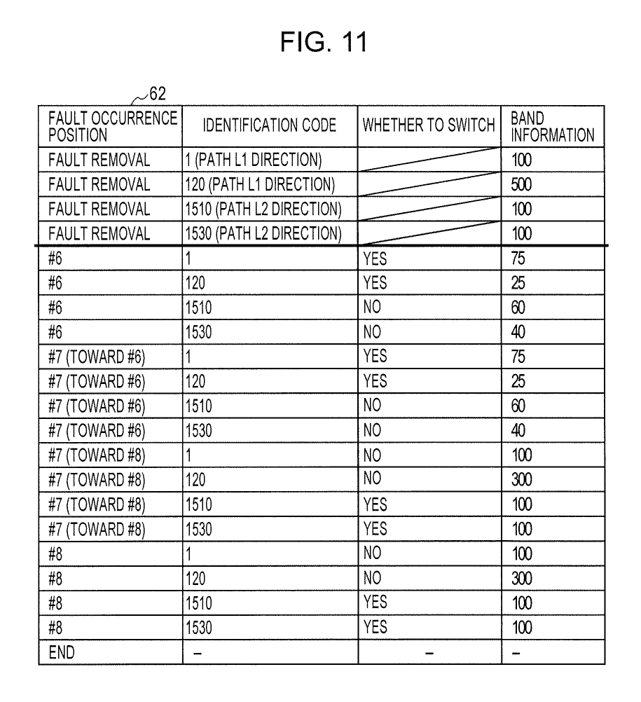

FIG. 11 illustrates an exemplary data structure of a recovery TB. As illustrated in FIG. 11, a recovery TB 62 has columns ‘FAULT OCCURRENCE POSITION’, ‘IDENTIFICATION CODE’, WHETHER TO SWITCH', and ‘BAND INFORMATION’.

The columns ‘FAULT OCCURRENCE POSITION’ and ‘IDENTIFICATION CODE’ illustrated in the recovery TB 62 of FIG. 11, except for four rows from the top, are the same as the columns ‘FAULT OCCURRENCE POSITION’ and ‘IDENTIFICATION CODE’ in the recovery TB 51 illustrated in FIG. 8, and the description thereof will be omitted. Note that packets of VLAN-IDs ‘1’ and ‘120’ illustrated in FIG. 11 are to be output to the path L1 when no signal failure has occurred. Packets of VLAN-IDs ‘1510’ and ‘1530’ are to be output to the path L2 when no signal failure has occurred. The four rows from the top of the recovery TB 62 will be described later.

Stored in the column ‘WHETHER TO SWITCH’ is information on whether the transmission path of a packet of the VLAN-ID associated with the fault occurrence position column is to be switched or not when a fault has occurred at a position indicated in the fault occurrence position column. For example, it can be seen that, when a signal failure has occurred at ‘#6’, the paths of packets of VLAN-IDs ‘1’ and ‘120’ are to be switched. It can also be seen that the paths of packets of VLAN-IDs ‘1510’ and ‘1530’ are not to be switched.

The band (in megahertz) after switching of the path of a packet is stored in the band information column. For example, it can be seen that, when a signal failure has occurred at ‘#6’, the bands of packets of VLAN-IDs ‘1’ and ‘120’ are restricted to ‘75’ and ‘25’, respectively. As for the packets of VLAN-IDs ‘1510’ and ‘1530’, it can be seen that although the paths of the packets themselves are not to be switched, their bands are restricted to ‘60’ and ‘40’, respectively, because of switching of the paths of the packets of VLAN-IDs ‘1’ and ‘120’.

The four rows from the top of the recovery TB 62 will now be described. In the band information column associated with ‘FAULT REMOVAL’ in the fault occurrence position column, the band information of a packet under the condition that a signal failure is removed (when no signal failure has occurred) is stored. For example, as for the packet of VLAN-ID ‘1’, it can be seen that its band information is ‘100’ when no signal failure has occurred.

Note that ‘END’ of the recovery TB 62 indicates the end of the recovery TB 62.

Here, assume that a fault has occurred at ‘#6’. In this case, as described above, as for the packets of VLAN-IDs ‘1’ and ‘120’, it can be seen from the recovery TB 62 that their paths are to be switched. Here, as for the packets of VLAN-IDs ‘1’ and ‘120’, the paths are each to be switched from the path L1 to the path L2.

As for the packets of VLAN-IDs ‘1510’ and ‘1530’, their paths are not to be switched with reference to the recovery TB 62. Accordingly, the packets of VLAN-IDs ‘1’, ‘120’, ‘1510’, and ‘1530’ are to be transmitted through the path L2. That is, the band of the path L2 becomes congested by the fault occurrence at ‘#6’.

However, as illustrated in the recovery TB 62, the bands of VLAN-IDs ‘1’ and ‘120’ are restricted from ‘100’ and ‘500’ to ‘75’ and ‘25’, respectively. Further, the bands of VLAN-IDs ‘1510’ and ‘1530’ are restricted from ‘100’ and ‘100’ to ‘60’ and ‘40’, respectively. Thus, the congestion in the band is removed in the path L2.

The blocks of the node 10 according to the fourth embodiment are similar to those of FIG. 6. However, the blocks in both embodiments differ from each other in part of functions of the path switch controller 43 and the route controller 44. The path switch controller 43 and the route controller 44 according to the fourth embodiment will be described below.

Upon receiving an FTFL message from the converter 41a or 41b, the path switch controller 43 refers to the recovery TB 62 on the basis of fault information included in the received FTFL message, and generates switch information regarding switching of the transmission path of the packet network. The path switch controller 43 outputs the generated switch information to the route controller 44.

For example, referring to the recovery TB 62 on the basis of the fault occurrence position included in an FTFL message, the path switch controller 43 acquires the VLAN-ID of a packet for which the transmission path is to be switched, and its band information. In addition, the path switch controller 43 acquires the band information regarding the VLAN-ID of a packet for which the transmission path corresponding to a fault occurrence position is not to be switched. The path switch controller 43 generates switch information including the acquired VLAN-ID and band information, and outputs the generated information to the route controller 44.

Specifically, in the case where the fault occurrence position included in an FTFL message is ‘#6’, the path switch controller 43 search the recovery TB 62 illustrated in FIG. 11 sequentially from the top, and acquires VLAN-IDs ‘1’, ‘120’, ‘1510’, and ‘1530’. The path switch controller 43 acquires band information associated with the acquired VLAN-IDs. Every time the path switch controller 43 acquires a VLAN-ID and the band information associated therewith, the path switch controller 43 generates switch information including the VLAN-ID and the band information associated therewith, and outputs the switch information to the route controller 44.

The route controller 44 switches the transmission path of the packet network on the basis of the switch information output from the path switch controller 43. For example, the route controller 44 stores beforehand, in a table that is not illustrated, the condition “The paths of VLAN-IDs ‘1’ and ‘120’ are each to be switched from the path L1 to the path L2.” Then, when the switch information including VLAN-IDs ‘1’ and ‘120’ is output from the path switch controller 43, the route controller 44 refers to the table that is not illustrated, and switches the paths for transmission of the packets of VLAN-IDs ‘1’ and ‘120’ each from the path L1 to the path L2. The route controller 44 also restricts the bands of VLAN-IDs ‘1’, ‘120’, ‘1510’, and ‘1530’ to ‘75’, ‘25’, ‘60’, and ‘40’, respectively.

Note that, upon receiving an FTFL message to the effect that a signal failure has been removed, the path switch controller 43 refers to the recovery TB 62 on the basis of the FTFL message. The path switch controller 43 acquires the identification code and band information associated with the fault removal, and generates revert information including these code and information. Upon receiving the revert information from the path switch controller 43, the route controller 44 causes the paths of VLAN-IDs ‘1’ and ‘120’ to each revert to the path L1. Then, the route controller 44 causes the bands of VLAN-IDs ‘1’, ‘120’, ‘1510’, and ‘1530’ to revert to ‘100’, ‘500’, ‘100’, and ‘100’, respectively.

In such a way, in the recovery TB 62 of the node 10, the band information regarding a packet after switching of its transmission path is stored beforehand in association with the fault occurrence position and the VLAN-ID. Then, the path switch controller 43 generates switch information including the band information, and the route controller 44 switches the transmission path of the packet in such a manner that the band is restricted. Thus, the node 10 can avoid band congestion of the paths L1 and L2.

The band of a low-priority packet is stored in such a manner as to be severely restricted, which enables the band of a high-priority packet to be secured even if a signal failure occurs.

Note that the packet network of the paths L1 and L2 is formed using the same nodes 10 and 70 in FIG. 10; however, the packet network may be formed via different nodes.

### Fifth Embodiment

A fifth embodiment will next be described in detail with reference to the drawings. In the fifth embodiment, the path of a packet is switched for every fault type of an FTFL. Hereinbelow, assume that an example of an OTN to which a node according to the fifth embodiment is applied is the same as that of FIG. 4.

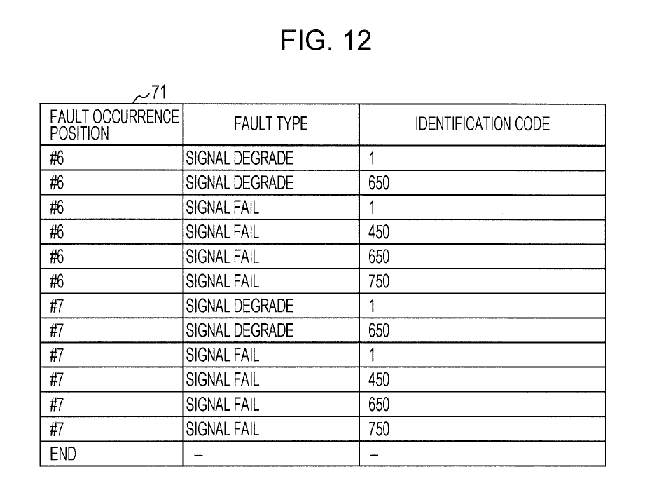

FIG. 12 illustrates an exemplary data structure of a recovery TB according to the fifth embodiment. As illustrated in FIG. 12, a recovery TB 71 has columns ‘FAULT OCCURRENCE POSITION’, ‘FAULT TYPE’, and ‘IDENTIFICATION CODE’.

The recovery TB 71 has the column ‘FAULT TYPE’ in addition to the columns of the recovery TB 51 illustrated in FIG. 8. The fault type is stored beforehand in association with the fault occurrence position and the identification code (VLAN-ID). The fault occurrence position column and the identification code column of the recovery TB 71 are the same as those in the recovery TB 51 described with reference to FIG. 8, and a description will be given below of the fault type.

As described above with reference to FIG. 5, information of no fault, a signal failure, and signal degradation of the OTN is stored in the fault indication field of an FTFL message. The information of signal degradation represents the state in which much information including errors is transmitted although connectivity of a signal is not lost. The signal degradation ('SIGNAL DEGRADE') or the signal failure ('SIGNAL FAIL') is stored in the fault type column.

In the fault type column of the recovery TB 71, conditions of switching of the transmission path of a packet are stored. For example, assume that signal degradation has occurred at ‘#6’ and signal degradation is stored in the fault indication field of an FTFL message. In this case, from the recovery TB 71 of FIG. 12, it can be seen that the transmission paths of packets of VLAN-IDs ‘1’ and ‘650’ are to be switched. Note that it can be seen that, as for packets of VLAN-IDs ‘450’ and ‘750’, their transmission paths are to be switched when a signal failure has occurred at ‘#6’, whereas their transmission paths are not to be switched when signal degradation has occurred.

The blocks of the node according to the fifth embodiment are similar to those of FIG. 6. However, the blocks in both embodiments differ from each other in part of functions of the path switch controller 43 and the route controller 44. The path switch controller 43 and the route controller 44 according to the fifth embodiment will be described below.

Upon receiving an FTFL message from the converter 41a or 41b, the path switch controller 43 refers to the recovery TB 71 on the basis of fault information included in the received FTFL message, and generates switch information on the transmission path in the packet network. The path switch controller 43 outputs the generated switch information to the route controller 44.

For example, referring to the recovery TB 71 on the basis of the fault occurrence position and the fault type that are included in the FTFL message, the path switch controller 43 acquires the VLAN-ID of a packet for which the transmission path is to be switched. The path switch controller 43 generates switch information including the acquired VLAN-ID, and outputs the information to the route controller 44.

Specifically, in the case where the fault occurrence position included in an FTFL message is ‘#6’ and the fault type is ‘SIGNAL DEGRADE’, the path switch controller 43 search the recovery TB 71 illustrated in FIG. 12 sequentially from the top, and acquires VLAN-IDs ‘1’ and ‘650’. Every time the path switch controller 43 acquires a VLAN-ID, the path switch controller 43 generates switch information including the VLAN-ID, and outputs the switch information to the route controller 44.

The route controller 44 switches the transmission path of the packet network on the basis of the switch information output from the path switch controller 43. For example, the route controller 44 stores beforehand, in a table that is not illustrated, the condition “The packet paths of VLAN-IDs ‘1’ and ‘650’ are to be switched each from the path L1 to the path L2.” Then, when the switch information including the VLAN-IDs ‘1’ and ‘650’ is output from the path switch controller 43, the route controller 44 refers to the table that is not illustrated, and switches the paths for transmission of the packets of the VLAN-IDs ‘1’ and ‘650’ each from the path L1 to the path L2.

Moreover, in the case where the fault occurrence position included in an FTFL message is ‘#6’ and the fault type is ‘SIGNAL FAIL’, the path switch controller 43 search the recovery TB 71 illustrated in FIG. 12 sequentially from the top, and acquires VLAN-IDs ‘1’, ‘450’, ‘650’, and ‘750’. Every time the path switch controller 43 acquires a VLAN-ID, the path switch controller 43 generates switch information including the VLAN-ID, and outputs the switch information to the route controller 44.

The route controller 44 switches the transmission path of the packet network on the basis of the switch information output from the path switch controller 43. For example, the route controller 44 switches the paths for transmission of the packets of VLAN-IDs ‘1’, ‘450’, ‘650’, and ‘750’ each from the path L1 to the path L2.

In this way, the node 10 receives an FTFL message of the OTN from the OTN. Then, the path switch controller 43 acquires, on the basis of the fault occurrence position and the fault type included in the FTFL message received by the converter 41a or 41b, the VLAN-ID of a packet on the layer 2 for which the transmission path is to be switched, and generates switch information including the acquired VLAN-ID. Thus, the node 10 can reduce unnecessary switching of the transmission path of the packet network, and it becomes possible to transmit a packet on a transmission path with fewer errors.

It also becomes possible for the node 10 to provide a packet network with high quality by transmitting a packet on a transmission path with fewer errors.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a receiver unit configured to receive, from a network on a first layer, fault information regarding the network on the first layer; and
a generator unit configured to generate, based on the fault information received by the receiver unit, switch information used to switch a transmission path of a network on a second layer higher than the first layer.

2. The transmission apparatus according to claim 1, further comprising:
a table in which a fault occurrence position in the network on the first layer and switch instruction information representing information on whether the transmission path of the network on the second layer is to be switched or not are stored beforehand in association with each other,
wherein the generator unit refers to the table, based on the fault occurrence position included in the fault information, and generates the switch information including the switch instruction information.

3. The transmission apparatus according to claim 1, further comprising:
a table in which a fault occurrence position in the network on the first layer and an identification code of a packet for which the transmission path of the network on the second layer is to be switched are stored beforehand in association with each other,
wherein the generator unit refers to the table, based on the fault occurrence position included in the fault information, and generates the switch information including the identification code.

4. The transmission apparatus according to claim 3,
wherein the table further stores beforehand band information regarding the packet after switching of the transmission path of the network on the second layer such that the band information is in association with the fault occurrence position and the identification code,
wherein the generator unit generates the switch information further including the band information.

5. The transmission apparatus according to claim 3,
wherein the table further stores beforehand a fault type of the network on the first layer in association with the fault occurrence position and the identification code,
wherein the generator unit refers to the table, based on the fault occurrence position and the fault type that are included in the fault information, and generates the switch information including the identification code.

6. The transmission apparatus according to claim 1, further comprising:
a path controller configured to switch the transmission path of the network on the second layer, based on the switch information generated by the generator unit.

7. The transmission apparatus according to claim 1,
wherein the switch information is output to an external path controller configured to switch the transmission path of the network on the second layer, based on the switch information.

8. The transmission apparatus according to claim 6,
wherein the generator unit generates the switch information in a data format of the second layer.

9. The transmission apparatus according to claim 7,
wherein the generator unit generates the switch information in a data format of the second layer.

10. A path switching method of a transmission apparatus for transmitting data, comprising:
receiving, from a network on a first layer, fault information regarding the network on the first layer; and
generating switch information on a transmission path of a network on a second layer higher than the first layer, based on the received fault information.
